(19) United States
(12) Patent Application Publication
(10) Pub. No.: US 2026/0302119 A1
(43) Pub. Date: Oct. 1, 2026

(54) FUSE UNIT AND CONDUCTIVE MODULE

(71) Applicant: YAZAKI CORPORATION, Tokyo (JP)

(72) Inventors: Mariko Nakagawa, Makinohara-shi (JP); Katsunori Sato, Makinohara-shi (JP); Isao Kameyama, Makinohara-shi (JP); Miho Suzuki, Makinohara-shi (JP); Yasuhiro Kominato, Makinohara-shi (JP); Kota Morishige, Makinohara-shi (JP)

(21) Appl. No.: 19/574,244

(22) Filed: Mar. 20, 2026

(30) Foreign Application Priority Data
Mar. 25, 2025 (JP) 2025-049841

(51) Int. Cl. H01H 85/00; H01H 85/02; H01H 85/175

(52) U.S. Cl. CPC H01H 85/003; H01H 85/0241; H01H 85/175; H01H 2085/0034; H01H 2223/002

(57) ABSTRACT

A fuse unit includes a fuse having a first electrode, a second electrode, and a fusible portion, a first conductive member bonded to the first electrode, a second conductive member bonded to the second electrode, a resin housing member molded integrally with the first conductive member and the second conductive member, and a sealing material. The housing member has a bottom wall and a tubular side wall to form a housing space. The housing space accommodates the fuse, a first joint portion, which is a joint portion between the first conductive member and the first electrode, and a second joint portion, which is a joint portion between the second conductive member and the second electrode.

### CROSS-REFERENCE TO RELATED APPLICATIONS

The present application claims priority to and incorporates by reference the entire contents of Japanese Patent Application No. 2025-049841 filed in Japan on Mar. 25, 2025.

### BACKGROUND OF THE INVENTION

### 1. Field of the Invention

The present invention relates to a fuse unit and a conductive module.

### 2. Description of the Related Art

Conventionally, there have been fuse units. Japanese Patent No. 7561318 discloses a fuse unit including a first terminal electrically connected to a mating member, a second terminal directly or indirectly electrically connected to a wiring member, a resin part covering a part of the first terminal and a part of the second terminal, and a chip fuse.

In fuse units, it is desired that a fuse and a joint portion between the fuse and a conductive member can be properly protected. For example, it is desirable to protect the fuse and the joint portion against foreign substances such as liquids.

### SUMMARY OF THE INVENTION

An object of the present invention is to provide a fuse unit and a conductive module that can properly protect a fuse and a joint portion between the fuse and a conductive member.

A fuse unit according to one aspect of the present invention includes a fuse including a first electrode, a second electrode, and a fusible portion between the first electrode and the second electrode; a first conductive member bonded to the first electrode; a second conductive member bonded to the second electrode; a resin housing member molded integrally with the first conductive member and the second conductive member; and a sealing material, wherein the housing member has a bottom wall and a tubular side wall erected from the bottom wall, the bottom wall and the side wall forming a housing space, the housing space accommodates the fuse, a first joint portion, and a second joint portion, the first joint portion being a joint portion between the first conductive member and the first electrode, the second joint portion being a joint portion between the second conductive member and the second electrode, the sealing material fills the housing space, and the fuse, the first joint portion, and the second joint portion are sealed from an external space by the bottom wall, the side wall, and the sealing material.

The above and other objects, features, advantages and technical and industrial significance of this invention will be better understood by reading the following detailed description of presently preferred embodiments of the invention, when considered in connection with the accompanying drawings.

### BRIEF DESCRIPTION OF THE DRAWINGS

FIG. 1 is a perspective view of a conductive module according to an embodiment;

FIG. 2 is a plan view of the conductive module according to the embodiment;

FIG. 3 is a perspective view of a fuse unit according to the embodiment;

FIG. 4 is a cross-sectional view of the fuse unit according to the embodiment;

FIG. 5 is a side view of the conductive module according to the embodiment;

FIG. 6 is a perspective view of the conductive module according to the embodiment;

FIG. 7 is a perspective view of the conductive module according to the embodiment;

FIG. 8 is a perspective view of the fuse unit according to the embodiment; and

FIG. 9 is a cross-sectional view of the conductive module according to the embodiment.

### DETAILED DESCRIPTION OF THE PREFERRED EMBODIMENTS

A fuse unit and a conductive module according to embodiments of the present invention will be described in detail below with reference to the drawings. The embodiments are not intended to limit this invention. The components in the following embodiments include those that can be readily conceived by those skilled in the art or are substantially the same.

### Embodiments

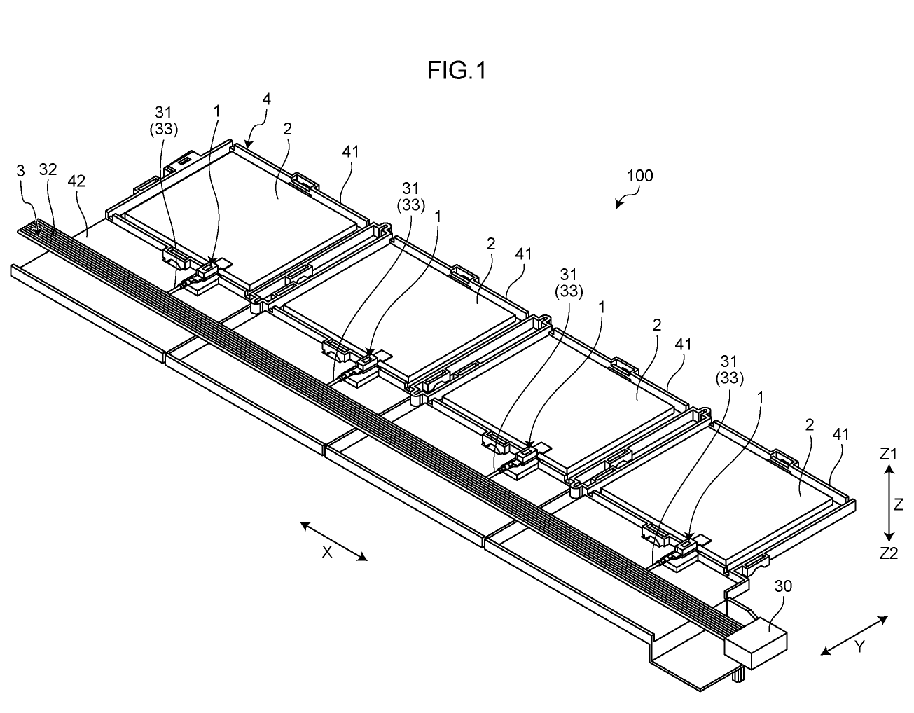

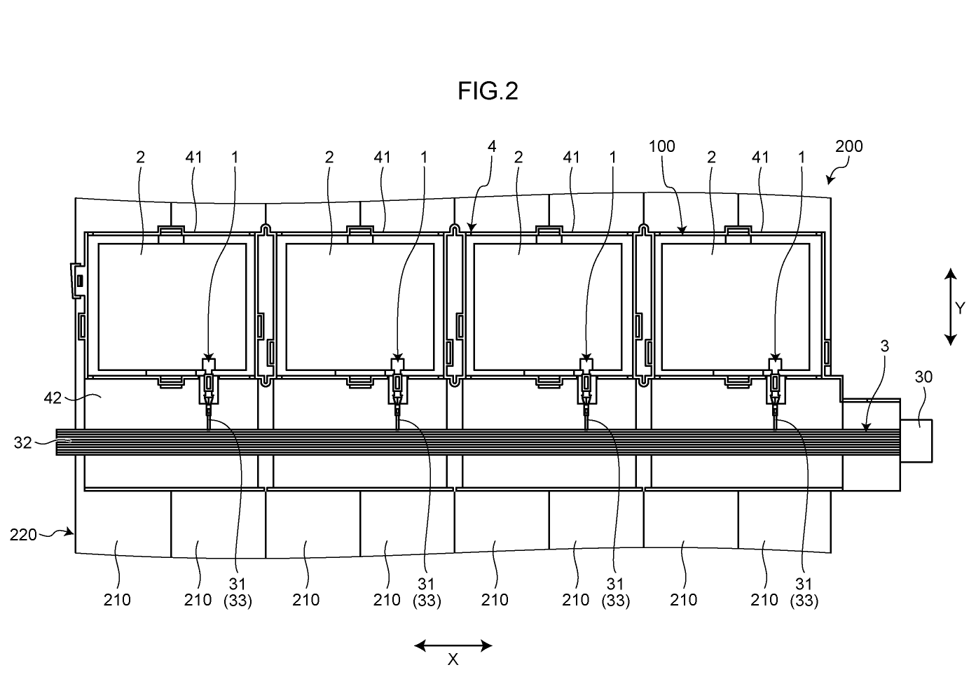

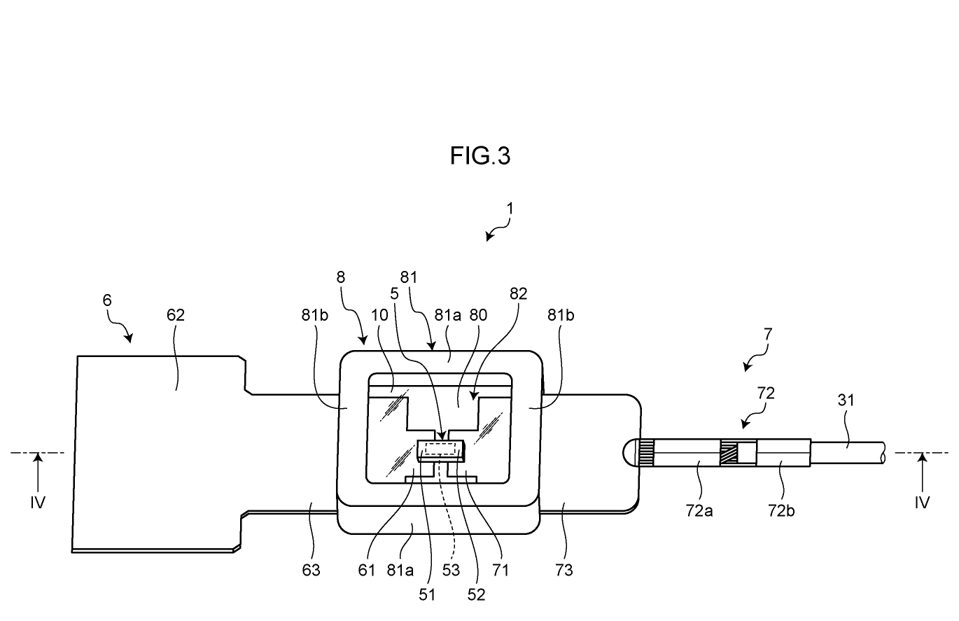

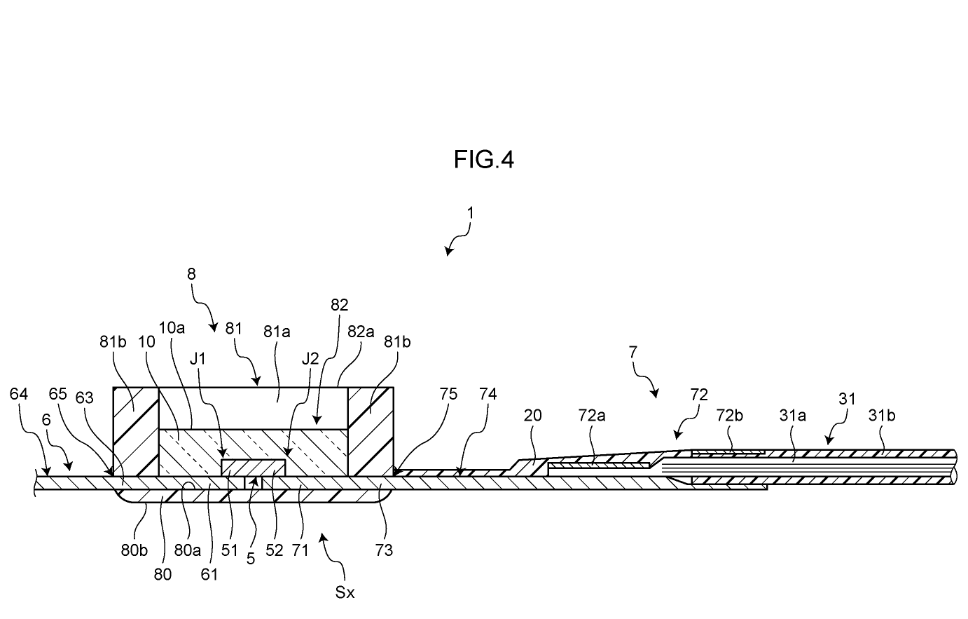

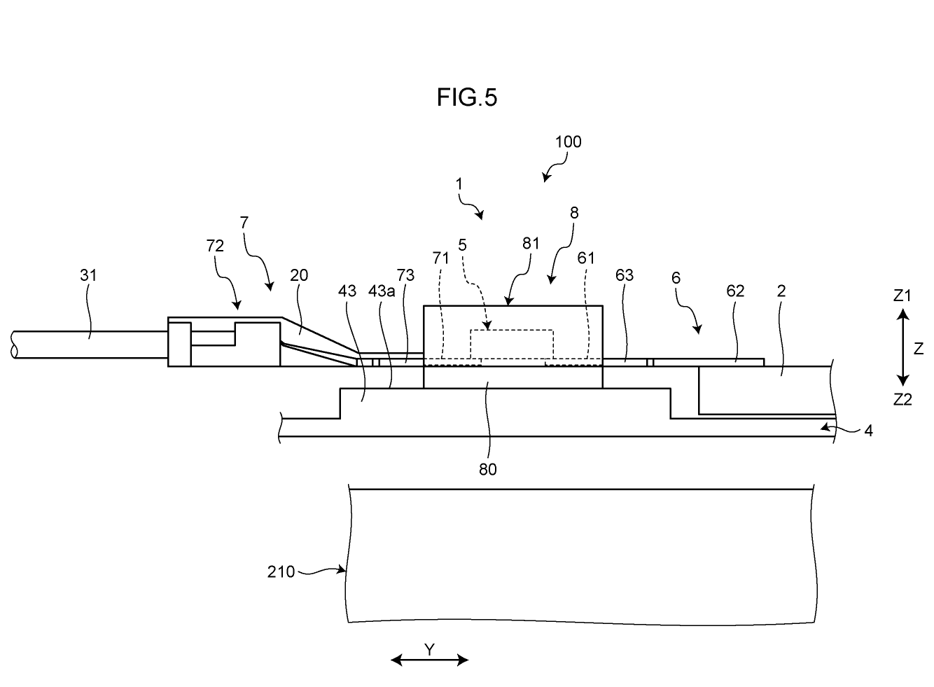

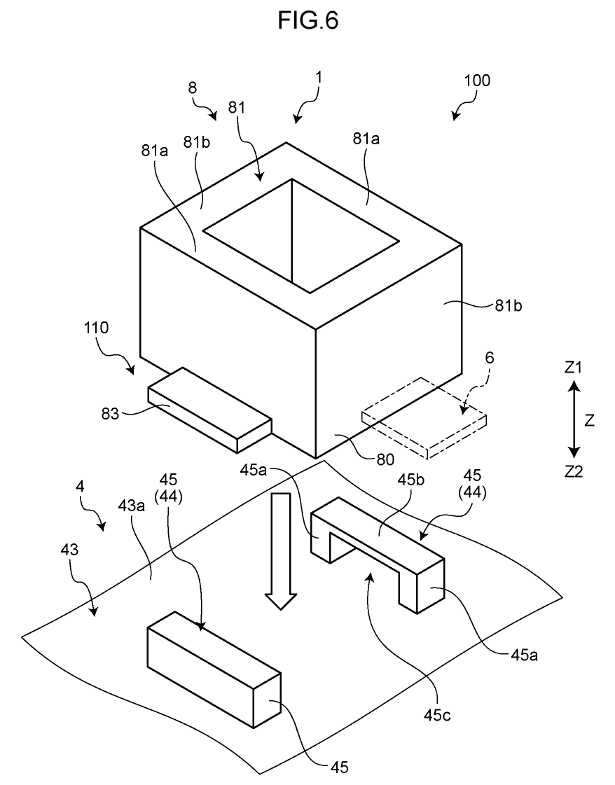

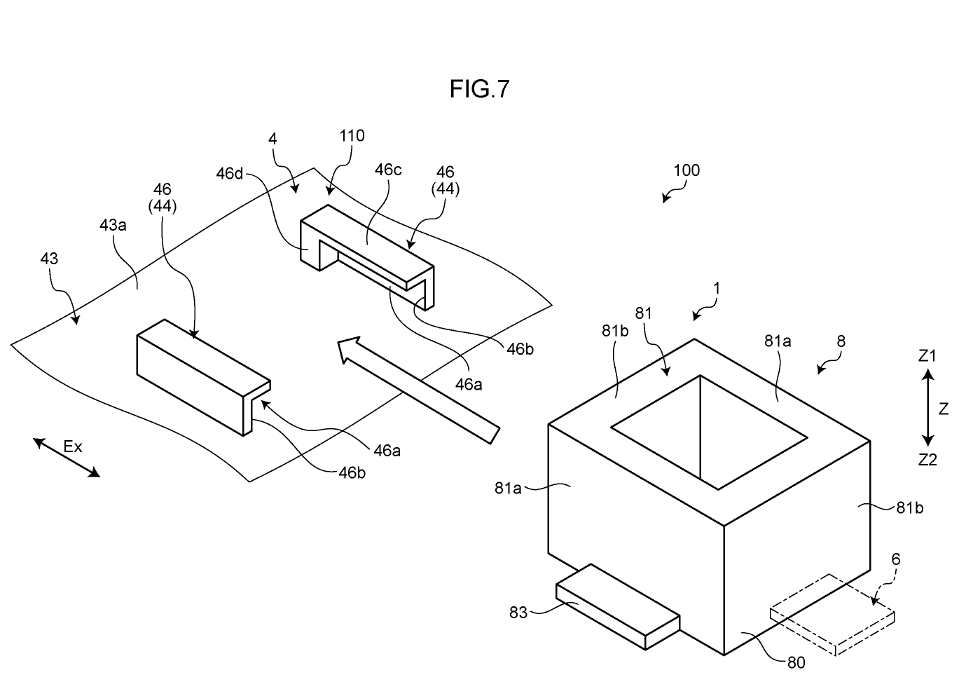

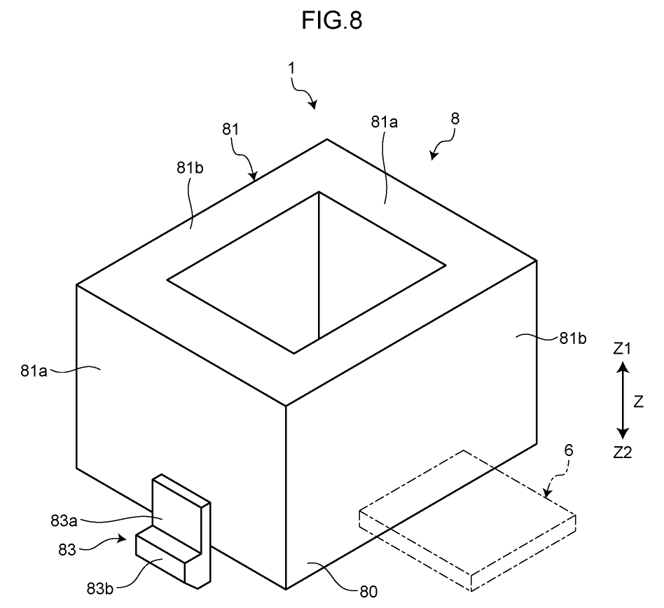

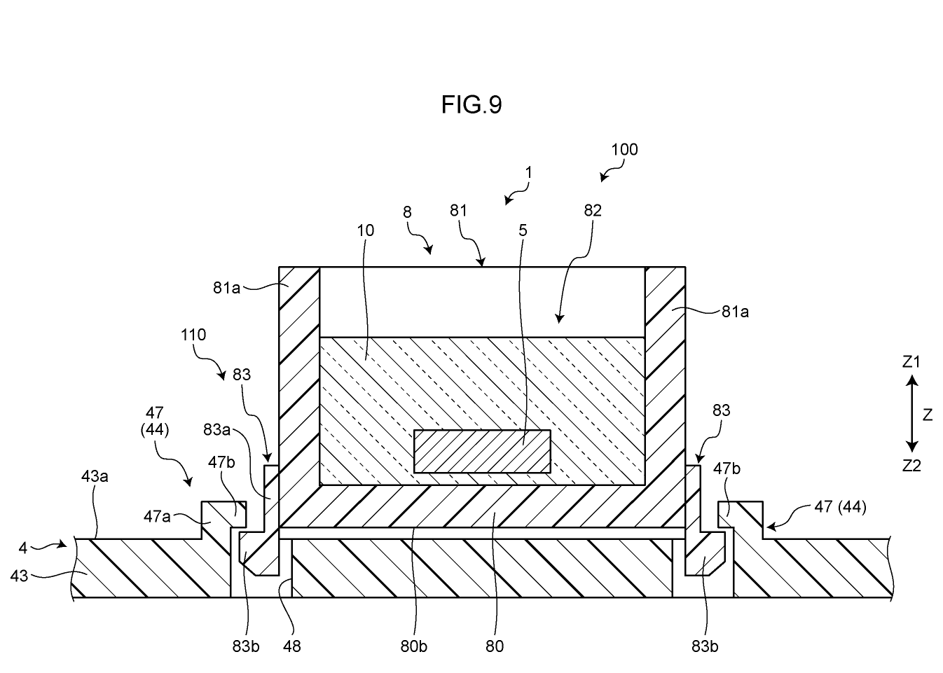

Referring to FIGS. 1 to 9, an embodiment will be described. The present embodiment relates to a fuse unit and a conductive module. FIG. 1 is a perspective view of a conductive module according to an embodiment, FIG. 2 is a plan view of the conductive module according to the embodiment, FIG. 3 is a perspective view of a fuse unit according to the embodiment, FIG. 4 is a cross-sectional view of the fuse unit according to the embodiment, FIG. 5 is a side view of the conductive module according to the embodiment, FIGS. 6 and 7 are perspective views of the conductive module according to the embodiment, FIG. 8 is a perspective view of the fuse unit according to the embodiment, and FIG. 9 is a cross-sectional view of the conductive module according to the embodiment. FIG. 4 depicts a cross section along IV-IV in FIG. 3.

As illustrated in FIG. 1, a conductive module 100 of the present embodiment is a busbar module including a fuse unit 1, a busbar 2, a wiring material 3, a case 4, and a connector 30. The conductive module 100 is disposed in a battery pack 200, for example, as illustrated in FIG. 2. The battery pack 200 is installed as a power source in a vehicle such as an automobile. The battery pack 200 includes a plurality of battery cells 210. The battery cells 210 are arranged along a first direction X. The battery cells 210 constitute a battery module 220. The conductive module 100 in FIG. 2 is assembled to the battery module 220.

The busbar 2 is formed of a conductive metal plate. The busbar 2 electrically connects two battery cells 210 adjacent to each other. More specifically, the busbar 2 is fixed to an electrode of one battery cell 210 and an electrode of another battery cell 210 to electrically connect the two electrodes. The conductive module 100 of the present embodiment includes a plurality of busbars 2 aligned in the first direction X and a plurality of fuse units 1 corresponding to the busbars 2.

The wiring material 3 includes a plurality of detection lines 31 and is routed along the first direction X. The wiring material 3 exemplified is a flat wiring material. The wiring material 3 exemplified is a flexible flat cable having a plurality of electric wires and a sheath covering the electric wires. Each of the electric wires is connected to a corresponding busbar 2 and serves as the detection line 31.

The wiring material 3 has a trunk line portion 32 and a plurality of branch portions 33. The trunk line portion 32 includes a plurality of electric wires and has a flat plate shape. The branch portions 33 branch off from the trunk line portion 32 toward a second direction Y and are routed to the busbars 2 and the like. The second direction Y is a direction orthogonal to the first direction X. The detection line 31 is connected to the fuse unit 1 from trunk line portion 32 via the branch portion 33. A connector 30 is disposed at an end of the trunk line portion 32. Each detection line 31 is connected to a terminal of the connector 30. The detection line 31 is connected, for example, to a monitoring device that monitors the battery pack 200. In this case, the monitoring device obtains a voltage of the battery cell 210 through the detection line 31 and monitors a state of the battery module 220.

The case 4 is a member that supports and accommodates the fuse unit 1, the busbar 2, and the wiring material 3, and is assembled to the battery pack 200. The case 4 is molded, for example, from an insulating synthetic resin. The case 4 has a holding portion 41 that holds the busbar 2 and a wiring path 42 that supports the wiring material 3. The case 4 of the present embodiment has a plurality of holding portions 41 aligned in the first direction X. The wiring path 42 is adjacent to the holding portions 41 in the second direction Y and extends in the first direction X. The trunk line portion 32 of the wiring material 3 is placed in the wiring path 42 so as to extend along the first direction X.

The fuse unit 1 is disposed between the detection line 31 and the busbar 2. As illustrated in FIG. 3, the fuse unit 1 includes a fuse 5, a first conductive member 6, a second conductive member 7, a resin housing member 8, and a sealing material 10. The fuse 5 is a circuit protection component that interrupts the circuit when an overcurrent flows. The fuse 5 of the present embodiment is a chip fuse.

As illustrated in FIG. 3, the fuse 5 includes a first electrode 51, a second electrode 52, and a fusible portion 53. The first electrode 51 is connected to one end of the fusible portion 53. The second electrode 52 is connected to the other end of the fusible portion 53. The fusible portion 53 is configured to interrupt current flow between the first electrode 51 and the second electrode 52 by melting when an overcurrent flows. The fusible portion 53 is, for example, a fuse element with predetermined fusing characteristics.

The first conductive member 6 and the second conductive member 7 are members having conductivity, for example, formed of metal plates. The first conductive member 6 is bonded to the first electrode 51 of the fuse 5. The second conductive member 7 is bonded to the second electrode 52 of the fuse 5. In other words, the fuse 5 is a protection component interposed between the first conductive member 6 and the second conductive member 7.

The first conductive member 6 has a first connection portion 61, a second connection portion 62, and an intermediate portion 63. The first conductive member 6 exemplified is a flat plate-shaped member having a linear shape in plan view. The first connection portion 61 is an end on one side of the first conductive member 6, and the second connection portion 62 is an end on the other side. The first connection portion 61 is formed such that it can be bonded to the first electrode 51 of the fuse 5. The first connection portion 61 has a rectangular flat plate shape and is slightly wider than the first electrode 51. The first connection portion 61 is bonded to the first electrode 51, for example, by means of solder.

The second connection portion 62 is formed such that it can be bonded to the busbar 2. The second connection portion 62 has a rectangular flat plate shape and is wider than the first connection portion 61. The second connection portion 62 is bonded to the busbar 2, for example, by means of solder or welding. The intermediate portion 63 is a portion between the first connection portion 61 and the second connection portion 62. The shape of the intermediate portion 63 in plan view is rectangular. The width of the intermediate portion 63 is larger than the width of the first connection portion 61 and smaller than the width of the second connection portion 62.

The second conductive member 7 has a first connection portion 71, a second connection portion 72, and an intermediate portion 73. The second conductive member 7 exemplified is a crimp terminal having a linear shape in plan view. The first connection portion 71 is an end on one side of the second conductive member 7, and the second connection portion 72 is an end on the other side. The first connection portion 71 is formed such that it can be bonded to the second electrode 52 of the fuse 5. The first connection portion 71 has a rectangular flat plate shape and is slightly wider than the second electrode 52.

The second connection portion 72 exemplified is a crimp portion that is crimped to the detection line 31. The second connection portion 72 has a core crimp portion 72a and a coating crimp portion 72b. The core crimp portion 72a is crimped onto the core of the detection line 31 and holds the core. The coating crimp portion 72b is crimped onto the insulation coating of the detection line 31 and holds the coating. The shape of the crimp portions 72a and 72b after crimping is, for example, cylindrical.

The intermediate portion 73 is a portion between the first connection portion 71 and the second connection portion 72. The shape of the intermediate portion 73 in plan view is rectangular. The width of the intermediate portion 73 is larger than the width of the first connection portion 71.

In the fuse unit 1 exemplified, the first conductive member 6, the fuse 5, and the second conductive member 7 are disposed linearly. In other words, the first conductive member 6 extends from the first electrode 51 on one side along the longitudinal direction of the fuse 5, and the second conductive member 7 extends from the second electrode 52 on the other side along the longitudinal direction.

As illustrated in FIGS. 3 and 4, the housing member 8 is molded integrally with the first conductive member 6 and the second conductive member 7, and holds the first conductive member 6 and the second conductive member 7. The housing member 8 is, for example, insert-molded from an insulating synthetic resin. In this case, the housing member 8 is molded on the first conductive member 6 and the second conductive member 7 held at a predetermined relative position by a mold. The housing member 8 is molded so as to expose two connection portions 61 and 62 of the first conductive member 6 and two connection portions 71 and 72 of the second conductive member 7. The fuse 5 may be connected to the conductive members 6 and 7 after the housing member 8 is formed, or may be connected to the conductive members 6 and 7 before the housing member 8 is formed.

The housing member 8 of the present embodiment has a bottom wall 80 and a tubular side wall 81. The bottom wall 80 exemplified is in the shape of a rectangular plate. As illustrated in FIG. 4, the bottom wall 80 has a first surface 80a and a second surface 80b. The first surface 80a is a surface facing a housing space 82 of the housing member 8. The fuse 5 is disposed on the first surface 80a side of the bottom wall 80 and is accommodated in the housing space 82. The side wall 81 is erected from the first surface 80a and surrounds the fuse 5. The second surface 80b is a surface facing the opposite side of the first surface 80a and faces an external space Sx of the housing member 8.

The side wall 81 exemplified has a rectangular frame shape. More specifically, the side wall 81 has a pair of flat plate-shaped first wall portions 81a and a pair of flat plate-shaped second wall portions 81b. The pair of first wall portions 81a face each other in the width direction of the conductive members 6 and 7. The pair of second wall portions 81b face each other in the longitudinal direction of the conductive members 6 and 7. The second wall portions 81b each extend from one of the first wall portions 81a to the other first wall portion 81a.

The bottom wall 80 and the side wall 81 of the housing member 8 form the housing space 82. The housing space 82 can accommodate the fuse 5 and the two first connection portions 61 and 71. The housing member 8 exemplified has the housing space 82 in the shape of an approximate rectangular parallelepiped.

The housing member 8 is formed such that the two conductive members 6 and 7 pass through the side wall 81. For example, the intermediate portion 63 of the first conductive member 6 passes through one of the second wall portions 81b. The first connection portion 61 is exposed in the interior space of the housing member 8, while the second connection portion 62 protrudes outside the housing member 8.

The intermediate portion 73 of the second conductive member 7 passes through the other second wall portion 81b. The first connection portion 71 is exposed in the interior space of the housing member 8, while the second connection portion 72 protrudes outside the housing member 8.

As illustrated in FIG. 4, the fuse 5 is disposed on the two first connection portions 61 and 71 on the opposite side of the bottom wall 80. The fuse unit 1 has a first joint portion J1 and a second joint portion J2. The first joint portion J1 is a joint portion between the first conductive member 6 and the first electrode 51 of the fuse 5. The second joint portion J2 is a joint portion between the second conductive member 7 and the second electrode 52 of the fuse 5. The fuse 5, the first joint portion J1, and the second joint portion J2 are accommodated in the housing space 82.

The bottom wall 80 and the side wall 81 shield the fuse 5 and the two joint portions J1 and J2 from the external space Sx of the housing member 8. In other words, the bottom wall 80 and the side wall 81 divide the fuse 5 and the two joint portions J1 and J2 from the external space Sx. The number of openings 82a of the housing space 82 of the present embodiment is one. The opening 82a is located at an end of the side wall 81 on the opposite side of the bottom wall 80.

The sealing material 10 fills the housing space 82. The sealing material 10 covers a protection target and protects the protection target against liquids and outside air. The sealing material 10 is, for example, an insulating synthetic resin. The sealing material 10 may be a potting agent. The sealing material 10 may be a resin that cures by ultraviolet light or the like. The sealing material 10 may be a transparent resin.

As illustrated in FIG. 4, the sealing material 10 fills the housing space 82 to prevent outside air from coming into contact with the fuse 5 and the two joint portions J1 and J2. In other words, the sealing material 10 covers the fuse 5 and the two joint portions J1 and J2 from the opening 82a side. In other words, the sealing material 10 is filled such that a boundary surface 10a with outside air in the sealing material 10 is located on the opening 82a side relative to the fuse 5 and the two joint portions J1 and J2.

The housing member 8 and the sealing material 10 form a closed space that accommodates the fuse 5 and the two joint portions J1 and J2. In other words, the bottom wall 80, the side wall 81, and the sealing material 10 seal the fuse 5, the first joint portion J1, and the second joint portion J2 from the external space Sx. The boundary surface 10a of the sealing material 10 is located on the opening 82a side relative to the fuse 5 and the two joint portions J1 and J2, and closes a passage formed by the side wall 81. The sealing material 10 therefore can protect the fuse 5 and the two joint portions J1 and J2 against foreign substances such as liquids that enter through the opening 82a. The housing member 8 does not have any opening that is communicatively connected to the external space Sx, except for the opening 82a. The bottom wall 80 and the side wall 81 therefore can protect the fuse 5 and the two joint portions J1 and J2 by restricting the entry of foreign substances such as liquids.

As illustrated in FIG. 4, the fuse unit 1 of the present embodiment has a protective layer 20. The protective layer 20 is an insulating layer that ensures insulation between the first conductive member 6 and the second conductive member 7. The protective layer 20 is formed of an insulating synthetic resin. The protective layer 20 is, for example, a resin layer cured by ultraviolet light or the like. The protective layer 20 exemplified is formed so as to cover at least an extending portion 74 of the second conductive member 7. The extending portion 74 is a portion of the second conductive member 7 that extends from the housing member 8 into the external space Sx. The extending portion 74 extends from the side wall 81 of the housing member 8, more specifically extends from the second wall portion 81b toward a direction orthogonal to the second wall portion 81b. The extending portion 74 includes, for example, a part of the intermediate portion 73 and the second connection portion 72.

The protective layer 20 is applied to the extending portion 74 so as to shield the extending portion 74 of the second conductive member 7 from the external space Sx. In this case, the protective layer 20 is applied so as to cover the entirety of the extending portion 74. The protective layer 20 may be applied to close a boundary 75 between the intermediate portion 73 and the housing member 8. The boundary 75 is a border where the intermediate portion 73 and the second wall portion 81b insert-molded on the intermediate portion 73 face each other. The protective layer 20 closes the boundary 75 from the external space Sx side, whereby the first joint portion J1 and the second joint portion J2 are sealed more reliably. The protective layer 20 may be formed so as to integrally cover the second conductive member 7 and the detection line 31.

As illustrated in FIG. 4, the detection line 31 has a core 31a and an insulating coating 31b that covers the core 31a. The protective layer 20 in FIG. 4 integrally covers the second conductive member 7, the core 31a, and the coating 31b. The insulating protective layer 20 can suppress electrical continuity between the two conductive members 6 and 7 even if an unanticipated event such as submersion in water occurs.

The fuse unit 1 of the present embodiment is produced, for example, by the following steps. A method of producing the fuse unit 1 includes a molding step, a fuse bonding step, a filling step, a detection line bonding step, and a protective layer forming step.

The molding step is a step of insert-molding the housing member 8 onto the two conductive members 6 and 7. The fuse bonding step is a step of bonding the fuse 5 to the two conductive members 6 and 7. The first connection portion 61 of the first conductive member 6 is bonded to the first electrode 51 of the fuse 5, and the first connection portion 71 of the second conductive member 7 is bonded to the second electrode 52 of the fuse 5.

The filling step is a step of filling the housing space 82 of the housing member 8 with the sealing material 10. The filled sealing material 10 seals the fuse 5 and the two joint portions J1 and J2 in an air-tight and gas-tight manner. The detection line bonding step is a step of bonding the second conductive member 7 to the detection line 31. The core crimp portion 72a of the second connection portion 72 is crimped onto the core 31a of the detection line 31, and the coating crimp portion 72b is crimped onto the coating 31b. The protective layer forming step is a step of forming the protective layer 20 on the second conductive member 7. The resin that forms the protective layer 20 is applied to the extending portion 74 of the second conductive member 7 and the detection line 31 and cured.

The protective layer 20 may be formed so as to cover an extending portion 64 of the first conductive member 6. As illustrated in FIG. 4, the first conductive member 6 has the extending portion 64. The extending portion 64 is a portion of the first conductive member 6 that extends from the housing member 8 into the external space Sx. The extending portion 64 extends from the side wall 81, more specifically extends from the second wall portion 81b toward a direction orthogonal to the second wall portion 81b. The extending portion 64 includes, for example, a part of the intermediate portion 63. The extending portion 64 may include a part of the second connection portion 62.

The protective layer 20 for the first conductive member 6 is applied to the extending portion 64 so as to shield the extending portion 64 from the external space Sx. In this case, the protective layer 20 is applied so as to cover the entirety of the extending portion 64. The protective layer 20 may be applied so as to close a boundary 65 between the intermediate portion 63 and the housing member 8 from the external space Sx side. The boundary 65 is a border where the intermediate portion 63 and the second wall portion 81b insert-molded on the intermediate portion 63 face each other.

When the protective layer 20 is formed on the extending portion 64 of the first conductive member 6, a resin is applied to the extending portion 64 and cured in the protective layer forming step. The protective layer 20 may be formed on both of the two extending portions 64 and 74 or any one of the two extending portions 64 and 74.

In the method of producing the fuse unit 1, for example, the molding step, the fuse bonding step, the filling step, the detection line bonding step, and the protective layer forming step are performed in this order. However, the order of the steps is not limited to this. For example, the order of the filling step and the detection line bonding step may be reversed.

The intermediate portion 63 of the first conductive member 6 may have a through hole. The housing member 8 is molded, for example, such that the through hole in the intermediate portion 63 is located in a region surrounded by the side wall 81. In this case, the resin that forms the bottom wall 80 can fill the through hole in the intermediate portion 63 and engage the intermediate portion 63. The intermediate portion 63 may have a recess and/or a protrusion that is engaged by the housing member 8. The housing member 8 may be molded such that the recess and/or the protrusion of the intermediate portion 63 is located inside the second wall portion 81b.

The intermediate portion 73 of the second conductive member 7 may have a through hole. The housing member 8 is molded, for example, such that the through hole in the intermediate portion 73 is located in a region surrounded by the side wall 81. In this case, the resin that forms the bottom wall 80 can fill the through hole in the intermediate portion 73 and engage the intermediate portion 73. The intermediate portion 73 may have a recess and/or a protrusion that is engaged by the housing member 8. The housing member 8 may be molded such that the recess and/or the protrusion of the intermediate portion 73 is located inside the second wall portion 81b.

When the intermediate portions 63 and 73 have a through hole and/or a recess and/or a protrusion, the holding strength of the housing member 8 for the conductive members 6 and 7 is improved. As a result, the fuse 5 and the joint portions J1 and J2 are protected more reliably. For example, when external force is input to the conductive members 6 and 7 outside the housing member 8, this external force is less likely to affect the joint portions J1 and J2.

As illustrated in FIG. 5, the housing member 8 of the fuse unit 1 is supported by a support surface 43a. The case 4 has a support wall 43 that supports the housing member 8. The support surface 43a is a surface of the support wall 43 and faces a first side Z1 of a third direction Z. The third direction Z is orthogonal to both of the first direction X and the second direction Y. For example, the third direction Z is a vertical direction of a vehicle. The first side Z1 is, for example, the upper side of the vehicle vertical direction. In this case, the support surface 43a supports the housing member 8 from below. The support surface 43a is typically a flat surface. The bottom wall 80 of the housing member 8 is supported by the support surface 43a. The support wall 43 may be a raised portion that is raised toward the third direction Z.

The case 4 may have an engagement structure 110 that engages the housing member 8 of the fuse unit 1, as described below. FIG. 6 illustrates the conductive module 100 having the engagement structure 110. The engagement structure 110 is a structure capable of engaging and holding the housing member 8 with the case 4. The engagement structure 110 includes a protruding portion 83 on the housing member 8 and an engagement portion 44 on the case 4.

The protruding portion 83 protrudes from the outer wall surface of the housing member 8. The engagement portion 44 engages the protruding portion 83 to hold the housing member 8. The protruding portion 83 in FIG. 6 protrudes from the outer wall surface of the side wall 81 toward a direction orthogonal to the side wall 81. The housing member 8 has two protruding portions 83. One of the protruding portions 83 protrudes from one of the first wall portions 81a, and the other protruding portion 83 protrudes from the other first wall portion 81a. The two protruding portions 83 protrude toward opposite sides of each other. The protruding portion 83 in FIG. 6 is formed in the shape of a rectangular plate and is elastically deformable.

The engagement portion 44 is disposed on the support wall 43 and is, for example, integral with the support wall 43. The engagement portion 44 in FIG. 6 has a frame portion 45 protruding from the support wall 43. The frame portion 45 protrudes from the support surface 43a of the support wall 43 toward the first side Z1 of the third direction Z. The frame portion 45 has a shape that can receive the protruding portion 83 and engage the protruding portion 83.

The shape of the frame portion 45 as viewed along the support surface 43a is, for example, an approximate U-shape. The frame portion 45 in FIG. 6 has a pair of columns 45a erected toward the third direction Z, and a beam 45b. The pair of columns 45a are spaced apart and face each other. The beam 45b extends from one of the columns 45a to the other column 45a and is spaced apart from the support surface 43a. The beam 45b and the pair of columns 45a form an opening 45c into which the protruding portion 83 can be inserted. The case 4 has two engagement portions 44 corresponding to the two protruding portions 83. The two engagement portions 44 are disposed with the openings 45c facing each other.

The housing member 8 is assembled to the case 4 with the bottom wall 80 facing the support wall 43. The housing member 8 in FIG. 6 is assembled to the case 4 in an orientation in which the bottom wall 80 faces the support surface 43a, while moving to the second side Z2 of the third direction Z. At this time, the protruding portion 83 is inserted between the pair of columns 45a over the beam 45b. In other words, the protruding portion 83 is inserted into the opening 45c. The engagement portion 44 engages the protruding portion 83 with the beam 45b and the pair of columns 45a to hold the housing member 8. The engagement portion 44 can engage the protruding portion 83 in both the third direction Z and the direction along the support surface 43a.

The housing member 8 is engaged by the case 4, whereby vibration of the fuse unit 1 is moderately suppressed. For example, even if vibration is transmitted to the fuse unit 1 through the busbar 2 or the wiring material 3, the amount of vibration of the fuse unit 1 is suppressed because the housing member 8 is engaged.

The engagement structure 110 allows the housing member 8 to move relative to the case 4 within a gap that exists between the frame portion 45 and the protruding portion 83. As a result, the joint portions J1 and J2 are less susceptible to external force when the first conductive member 6 is bonded to the busbar 2. For example, when the first conductive member 6 is bonded to the busbar 2 by ultrasonic vibration, the load due to vibration on the joint portions J1 and J2 is reduced.

FIG. 7 illustrates another example of the engagement structure 110. In the engagement structure 110 in FIG. 7, the engagement portion 44 has a groove 46a extending along the support wall 43. More specifically, the engagement portion 44 in FIG. 7 includes a guide 46 disposed on the support wall 43. The case 4 in FIG. 7 has a pair of guides 46. The guide 46 protrudes from the support surface 43a toward the first side Z1 of the third direction Z. The guide 46 has the groove 46a extending along the support surface 43a. The direction in which the groove 46a extends is referred to as extension direction Ex. The extension direction Ex is, for example, the second direction Y.

The two guides 46 are disposed with the grooves 46a facing each other. In other words, the groove 46a of one of the guides 46 opens toward the other guide 46. The groove 46a has an insertion opening 46b open toward one side of the extension direction Ex.

The guide 46 has a guide wall 46c and a stopper 46d. The guide wall 46c is a wall portion that forms the groove 46a and is along the extension direction Ex. The guide wall 46c faces the support surface 43a in the third direction Z. The stopper 46d is disposed at the back in the extension direction Ex of the groove 46a and engages the protruding portion 83.

The protruding portion 83 in FIG. 7 is, for example, a piece protruding from the first wall portion 81a, similar to the protruding portion 83 in FIG. 6. The housing member 8 is assembled to the case 4 with the bottom wall 80 facing the support wall 43. The housing member 8 in FIG. 7 is assembled to the case 4 in an orientation in which the bottom wall 80 faces the support surface 43a, while moving in the extension direction Ex. The protruding portion 83 is inserted into the groove 46a through the insertion opening 46b. The protruding portion 83 is inserted into the groove 46a, for example, to reach a position in contact with the stopper 46d.

The engagement portion 44 may sandwich the protruding portion 83 between the guide wall 46c and the support surface 43a. In this case, the protruding portion 83 may be press-fitted between the guide wall 46c and the support wall 43. The guide 46 or the support wall 43 may have a projection that engages the protruding portion 83 accommodated in the groove 46a. This projection may be provided in a position that can suppress the protruding portion 83 from slipping out of the groove 46a.

The engagement structure 110 in FIG. 7 allows the housing member 8 to move relative to the case 4 within a gap that exists between the guide 46 and the protruding portion 83. As a result, the load on the joint portions J1 and J2 is suppressed when the first conductive member 6 is bonded to the busbar 2.

FIGS. 8 and 9 illustrate yet another example of the engagement structure 110. The protruding portion 83 illustrated in FIG. 8 is a locking arm. The protruding portion 83 protrudes from the outer wall surface of the bottom wall 80 toward a direction orthogonal to the bottom wall 80. As illustrated in FIG. 9, a distal end of the protruding portion 83 protrudes toward the opposite side of the side wall 81 relative to the second surface 80b. The housing member 8 has two protruding portions 83. One of the protruding portions 83 is disposed on one of the first wall portions 81a and the other protruding portion 83 is disposed on the other first wall portion 81a.

The protruding portion 83 has a piece 83a and a pawl 83b. The piece 83a has a flat plate shape and extends in a direction orthogonal to the bottom wall 80. A distal end of the piece 83a protrudes relative to the second surface 80b. The pawl 83b protrudes from the distal end of the piece 83a. Two pawls 83b protrude toward opposite sides of each other.

As illustrated in FIG. 9, the engagement portion 44 of the case 4 has an engagement wall 47 that engages the pawl 83b. The engagement wall 47 illustrated in FIG. 9 has a base portion 47a protruding from the support surface 43a and a pawl portion 47b protruding from a distal end of the base portion 47a. The support wall 43 has a hole 48 into which the protruding portion 83 can be inserted. The hole 48 may be a through hole passing through the support wall 43. The base portion 47a of the engagement wall 47 is erected from the vicinity of the hole 48 toward the third direction Z. The pawl portion 47b protrudes from the base portion 47a so as to face the hole 48 in the third direction Z. The case 4 has two engagement walls 47 and two holes 48 corresponding to two protruding portions 83. The two engagement walls 47 are disposed with the pawl portions 47b facing each other.

The housing member 8 is assembled to the case 4 with the bottom wall 80 facing the support wall 43. The housing member 8 in FIG. 9 is assembled to the case 4 in an orientation in which the bottom wall 80 faces the support surface 43a, while moving to the second side Z2 of the third direction Z. At this time, the pawl 83b of the protruding portion 83 comes into contact with the pawl portion 47b of the case 4. The protruding portion 83 is inserted into the hole 48 over the pawl portion 47b while allowing the piece 83a to be flexed and deformed. The pawl portion 47b of the engagement portion 44 engages the pawl 83b of the protruding portion 83 and holds the housing member 8.

The engagement portion 44 in FIG. 9 may be a frame portion similar to the frame portion 45 in FIG. 6. In this case, a portion corresponding to the beam 45b serves as the pawl portion 47b of the engagement wall 47. The engagement portion 44 in FIG. 9 may be a guide similar to the guide 46 in FIG. 7. In this case, a portion corresponding to the guide wall 46c serves as the pawl portion 47b of the engagement wall 47.

The engagement structure 110 illustrated in FIG. 9 allows the housing member 8 to move relative to the case 4 within a gap that exists between the engagement wall 47 and the protruding portion 83. As a result, the joint portions J1 and J2 are less susceptible to large force when the first conductive member 6 is bonded to the busbar 2.

As explained above, the fuse unit 1 of the present embodiment includes the fuse 5, the first conductive member 6, the second conductive member 7, the housing member 8, and the sealing material 10. The fuse 5 includes the first electrode 51, the second electrode 52, and the fusible portion 53 between the first electrode 51 and the second electrode 52. The first conductive member 6 is bonded to the first electrode 51. The second conductive member 7 is bonded to the second electrode 52. The resin housing member 8 is molded integrally with the first conductive member 6 and the second conductive member 7.

The housing member 8 has the bottom wall 80 and the tubular side wall 81 erected from the bottom wall 80. The bottom wall 80 and the side wall 81 form the housing space 82. The fuse 5, the first joint portion J1, and the second joint portion J2 are accommodated in the housing space 82. The first joint portion J1 is a joint portion between the first conductive member 6 and the first electrode 51. The second joint portion J2 is a joint portion between the second conductive member 7 and the second electrode 52. The sealing material 10 fills the housing space 82. The fuse 5, the first joint portion J1, and the second joint portion J2 are sealed from the external space Sx by the bottom wall 80, the side wall 81, and the sealing material 10. The fuse unit 1 of the present embodiment can seal and properly protect the fuse 5 and two joint portions J1 and J2.

The sealing material 10 may be a transparent potting agent. In this case, a state of the fuse 5 and the joint portions J1 and J2 can be viewed from the outside after the sealing material 10 is filled into the housing space 82.

The fuse unit 1 of the present embodiment has the protective layer 20. The protective layer 20 covers at least one of the extending portion 64 of the first conductive member 6 and the extending portion 74 of the second conductive member 7. The extending portions 64 and 74 are portions of the first conductive member 6 and the second conductive member 7 that extend from the housing member 8 into the external space Sx. The protective layer 20 is formed of an insulating resin. The protective layer 20 can suppress the occurrence of unnecessary electrical continuity between the first conductive member 6 and the second conductive member 7.

The conductive module 100 of the present embodiment includes the fuse unit 1 described in the embodiment, the busbar 2 connected to the first conductive member 6, the wiring material 3 connected to the second conductive member 7, and the case 4. The case 4 is a member that supports the fuse unit 1, the busbar 2, and the wiring material 3. The housing member 8 has the protruding portion 83 protruding from the outer wall surface of the housing member 8. The case 4 has the engagement portion 44 that engages the protruding portion 83. The housing member 8 is engaged by the case 4, whereby the orientation of the fuse unit 1 is stabilized. In addition, the amount of vibration of the fuse unit 1 is suppressed because the housing member 8 is engaged.

The case 4 of the present embodiment has the support wall 43 that supports the housing member 8. The housing member 8 has a plurality of protruding portions 83 protruding toward a direction orthogonal to the side wall 81 and is assembled to the case 4 with the bottom wall 80 facing the support wall 43. The engagement portion 44 may have the frame portion 45 protruding from the support wall 43. In this case, the engagement portion 44 receives the protruding portion 83 in the frame portion 45 and engages the protruding portion 83. Preferably, at least one of the protruding portion 83 and the frame portion 45 is elastically deformable. The frame portion 45 can define a movable range of the protruding portion 83 relative to the case 4.

The engagement portion 44 may have the groove 46a extending along the support wall 43. In this case, the engagement portion 44 engages the protruding portion 83 inserted into the groove 46a. The engagement portion 44 may hold the protruding portion 83 between the engagement portion 44 and the support wall 43.

The protruding portion 83 may be a flexible locking arm having the pawl 83b. The engagement portion 44 may engage the pawl 83b of the protruding portion 83. The case 4 in FIG. 9 had the hole 48, but the case 4 is not limited to having the hole 48.

The application of the fuse unit 1 is not limited to the conductive module 100 for the battery pack 200. The fuse unit 1 may be applied as a protective circuit for other devices. The target to which the first conductive member 6 is connected is not limited to the busbar 2. The second connection portion 62 of the first conductive member 6 may be connected to a wiring material such as an electric wire or may be connected to other conductive members. The target to which the second conductive member 7 is connected is not limited to an electric wire. The second connection portion 72 of the second conductive member 7 may be connected to a circuit or the like of a flexible printed circuit board or may be connected to other conductive members.

The contents disclosed in the above embodiments may be combined and implemented as appropriate.

In the fuse unit according to the present embodiment, the fuse, the first joint portion, and the second joint portion are sealed from an external space by the bottom wall, the side wall, and the sealing material of the housing member. The fuse unit according to the present embodiment has the effect of properly protecting the fuse and the joint portion between the fuse and the conductive member.

Although the invention has been described with respect to specific embodiments for a complete and clear disclosure, the appended claims are not to be thus limited but are to be construed as embodying all modifications and alternative constructions that may occur to one skilled in the art that fairly fall within the basic teaching herein set forth.

What is claimed is:

1. A fuse unit comprising:
a fuse including a first electrode, a second electrode, and a fusible portion between the first electrode and the second electrode;
a first conductive member bonded to the first electrode;
a second conductive member bonded to the second electrode;
a resin housing member molded integrally with the first conductive member and the second conductive member; and
a sealing material, wherein
the housing member has a bottom wall and a tubular side wall erected from the bottom wall, the bottom wall and the side wall forming a housing space,
the housing space accommodates the fuse, a first joint portion, and a second joint portion, the first joint portion being a joint portion between the first conductive member and the first electrode, the second joint portion being a joint portion between the second conductive member and the second electrode,
the sealing material fills the housing space, and
the fuse, the first joint portion, and the second joint portion are sealed from an external space by the bottom wall, the side wall, and the sealing material.

2. The fuse unit according to claim 1, wherein
the sealing material is a transparent potting agent.

3. The fuse unit according to claim 1, further comprising:
a protective layer covering at least one of an extending portion of the first conductive member and an extending portion of the second conductive member, wherein
the extending portions are portions of the first conductive member and the second conductive member that extend from the housing member into an external space, and
the protective layer is formed of an insulating resin.

4. A conductive module comprising:
the fuse unit according to claim 1;
a busbar connected to the first conductive member;
a wiring material connected to the second conductive member; and
a case supporting the fuse unit, the busbar, and the wiring material, wherein
the housing member has a protruding portion protruding from an outer wall surface of the housing member, and
the case has an engagement portion that engages the protruding portion.

5. The conductive module according to claim 4, wherein
the case has a support wall supporting the housing member,
the housing member has a plurality of the protruding portions protruding toward a direction orthogonal to the side wall and is assembled to the case with the bottom wall facing the support wall, and
the engagement portion has a frame portion protruding from the support wall and receives the protruding portion in the frame portion to engage the protruding portion.

6. The conductive module according to claim 4, wherein
the case has a support wall supporting the housing member,
the housing member has a plurality of the protruding portions protruding toward a direction orthogonal to the side wall and is assembled to the case with the bottom wall facing the support wall, and
the engagement portion has a groove extending along the support wall and engages the protruding portion inserted into the groove.

7. The conductive module according to claim 4, wherein
the case has a support wall supporting the housing member,
the housing member has a plurality of the protruding portions protruding toward a direction orthogonal to the bottom wall and is assembled to the case with the bottom wall facing the support wall,
the protruding portion is a flexible locking arm having a pawl, and
the engagement portion engages the pawl of the protruding portion.
